(19) United States
(12) Patent Application Publication
(10) Pub. No.: US 2014/0210829 A1
(43) Pub. Date: Jul. 31, 2014

(54) ELECTRONIC APPARATUS AND HANDWRITTEN DOCUMENT PROCESSING METHOD

(71) Applicant: KABUSHIKI KAISHA TOSHIBA, Tokyo (JP)

(72) Inventor: Sachie Yokoyama, Ome-shi (JP)

(73) Assignee: KABUSHIKI KAISHA TOSHIBA, Tokyo (JP)

(21) Appl. No.: 13/966,599

(22) Filed: Aug. 14, 2013

Related U.S. Application Data
(63) Continuation of application No. PCT/JP2013/058158, filed on Mar. 21, 2013.

(30) Foreign Application Priority Data
Jan. 31, 2013 (JP) 2013-017201

(51) Int. Cl. G09G 5/24

(52) U.S. Cl. CPC G09G 5/24
USPC 345/467

(57) ABSTRACT

According to one embodiment, an electronic apparatus includes a display controller and a processor. The display controller displays a first graphic object of a plurality of graphic objects on a screen. The processor change, if a stroke is handwritten and at least a part of the stroke overlaps with the first graphic object, the first graphic object to a second graphic object which is different from the first graphic object, based on the stroke and the first graphic object. The display controller displays the second graphic object in place of the first graphic object.

### CROSS REFERENCE TO RELATED APPLICATIONS

This application is a Continuation Application of PCT Application No. PCT/JP2013/058158, filed Mar. 21, 2013 and based upon and claiming the benefit of priority from Japanese Patent Application No. 2013-017201, filed Jan. 31, 2013, the entire contents of all of which are incorporated herein by reference.

### FIELD

Embodiments described herein relate generally to processing of a handwritten document.

### BACKGROUND

In recent years, various kinds of electronic apparatuses, such as a tablet, a PDA and a smartphone, have been developed. Most of these electronic apparatuses include touch-screen displays for facilitating input operations by users.

By touching a menu or an object, which is displayed on the touch-screen display, by a finger or the like, the user can instruct an electronic apparatus to execute a function which is associated with the menu or object.

Among such electronic apparatuses, there is an electronic apparatus including a function for a user to handwrite characters or graphics on the touch-screen display. A handwritten document (handwritten page) including such handwritten characters and graphics is stored and is viewed where necessary.

There is a case in which a handwritten graphic in a handwritten document is converted to a graphic object by various graphic recognition processes. However, in some cases, the handwritten graphic is recognized as a graphic object, which does not agree with the user's intention, and correction of the handwritten graphic is needed, since the shape of the handwritten graphic varies from user to user, or a rough shape, such as a scribbled shape, is handwritten. In addition, even when the handwritten graphic has been recognized as a graphic object which agrees with the user's intention, there is a case in which the user wishes to change the graphic object to another graphic object.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an external appearance of an electronic apparatus according to an embodiment.

FIG. 2 is a view illustrating an example of a handwritten document processed by the electronic apparatus of the embodiment.

FIG. 3 is a view for explaining time-series information corresponding to the handwritten document of FIG. 2, the time-series information being stored in a storage medium by the electronic apparatus of the embodiment.

FIG. 4 is a block diagram illustrating a system configuration of the electronic apparatus of the embodiment.

FIG. 5 is a block diagram illustrating a functional configuration of a digital notebook application program executed by the electronic apparatus of the embodiment.

FIG. 6 is a view for describing an example in which handwritten graphics are converted to graphic objects by the electronic apparatus of the embodiment.

FIG. 7 is a view illustrating a first example in which an erroneously recognized graphic object is corrected by the electronic apparatus of the embodiment.

FIG. 8 is a view illustrating a structure example of graphic dictionary data used by the electronic apparatus of the embodiment.

FIG. 9 is a view illustrating a second example in which an erroneously recognized graphic object is corrected by the electronic apparatus of the embodiment.

FIG. 10 is a view illustrating a third example in which an erroneously recognized graphic object is corrected by the electronic apparatus of the embodiment.

FIG. 11 is a view illustrating a fourth example in which an erroneously recognized graphic object is corrected by the electronic apparatus of the embodiment.

FIG. 12 is a flowchart illustrating an example of the procedure of a recognition process executed by the electronic apparatus of the embodiment.

FIG. 13 is a flowchart illustrating an example of the procedure of a graphic object correction process executed by the electronic apparatus of the embodiment.

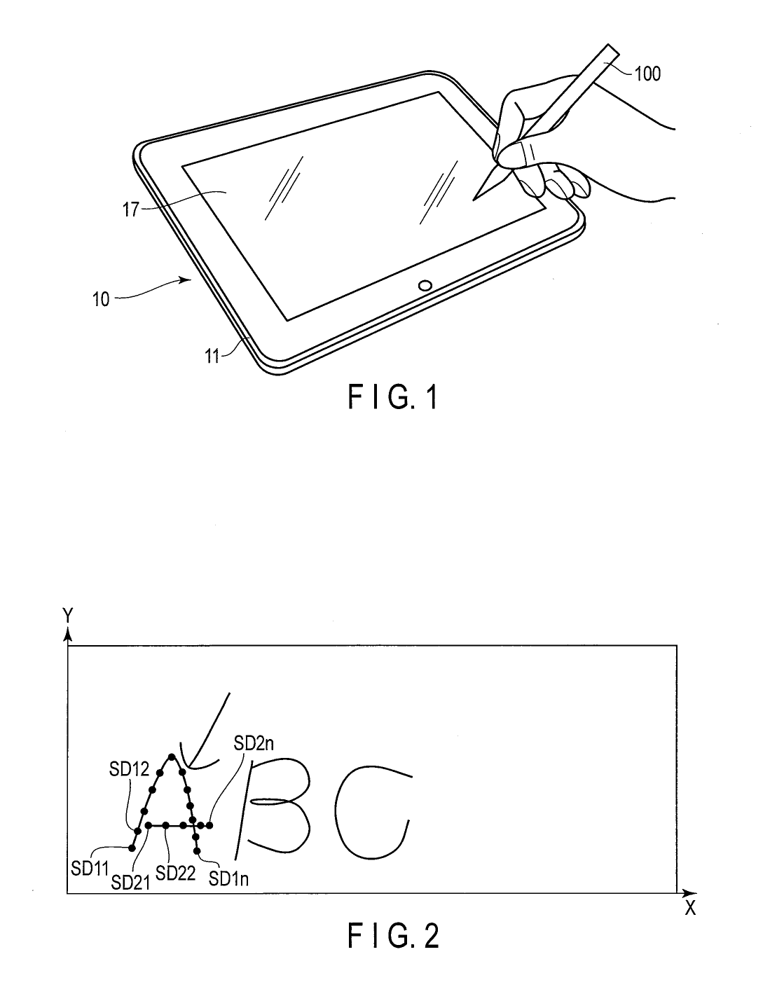

### DETAILED DESCRIPTION

Various embodiments will be described hereinafter with reference to the accompanying drawings.

In general, according to one embodiment, an electronic apparatus includes a display controller and a processor. The display controller is configured to display a first graphic object of a plurality of graphic objects on a screen. The processor is configured to change, if a stroke is handwritten and at least a part of the stroke overlaps with the first graphic object, the first graphic object to a second graphic object which is different from the first graphic object, based on the stroke and the first graphic object. The display controller is configured to display the second graphic object in place of the first graphic object.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

Each of the digitizer and touch panel is provided in a manner to cover the screen of the flat-panel display. The touch-screen display 17 can detect not only a touch operation on the screen with use of a finger, but also a touch operation on the screen with use of a pen 100. The pen 100 may be, for instance, an electromagnetic-induction pen.

The user can execute a handwriting operation of inputting a plurality of strokes by handwriting, on the touch-screen display 17 by using an external object (pen 100 or finger). During the handwriting input operation, a locus of movement of the external object (pen 100 or finger) on the screen, that is, a locus of a stroke (writing trace) that is handwritten by the handwriting input operation, is drawn in real time, and thereby the loci of strokes are displayed on the screen. A locus of movement of the external object during a time in which the external object is in contact with the screen corresponds to one stroke. A set of many strokes corresponding to handwritten characters or handwritten graphics, that is, a set of many loci (writing traces), constitutes a handwritten document.

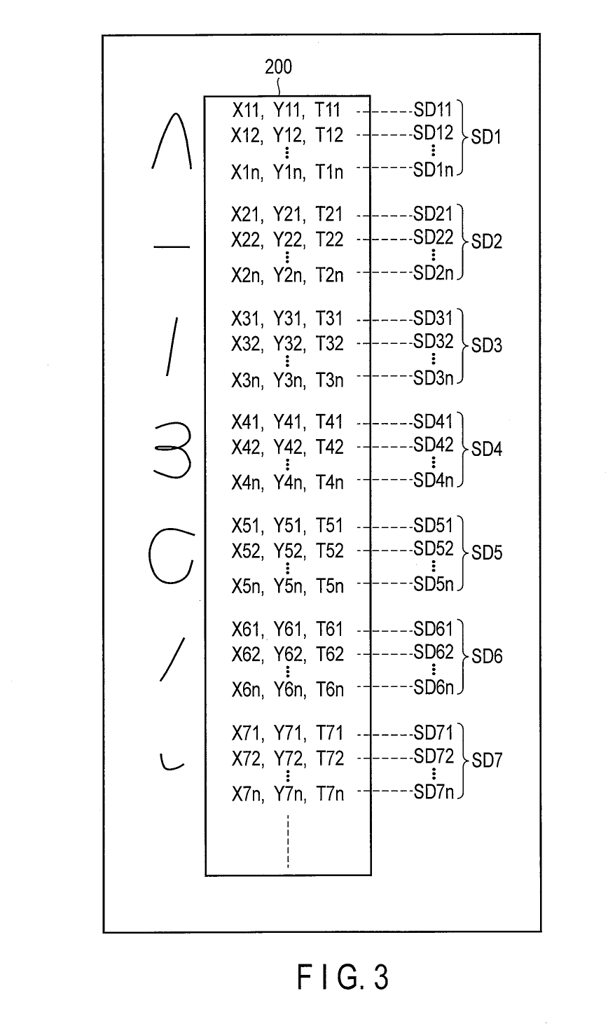

In the present embodiment, this handwritten document is stored in a storage medium not as image data but as handwritten document data including time-series information indicative of coordinate series of the loci of strokes and the order relation between the strokes. The details of this time-series information will be described later with reference to FIG. 3. In general, this time-series information means a set of time-series stroke data corresponding to a plurality of strokes. Each stroke data may be of any kind if it can express one stroke which can be input by handwriting, and each stroke data includes, for example, coordinate data series (time-series coordinates) corresponding to points on the locus of this stroke. The order of arrangement of these stroke data corresponds to an order in which strokes were handwritten, that is, an order of strokes.

The handwritten document may include not only handwritten characters and graphics, but also character codes and graphic objects (e.g. a character code or a graphic object recognized from a handwritten character or graphic). The graphic object may be any graphic object if it is defined by an application, and may be, for instance, a line such as a straight line, a curve, a Bezier curve or an arrow line, a figure such as a rectangle, a triangle, a hexagon, a pentagram or a rounded-cornered figure, a flowchart, a diagram such as a block diagram, a tree diagram or a matrix, a table, etc. In this case, the handwritten document data may include character code data and graphic object data representative of a character code and a graphic object in the document.

In addition, the user can edit (correct) a graphic object in a document which is being displayed, by the above-described handwriting input operation.

The tablet computer 10 can read arbitrary existing handwritten document data from the storage medium, and can display on the screen a handwritten document corresponding to this handwritten document data, that is, a handwritten document on which the loci corresponding to a plurality of strokes indicated by time-series information, a character code indicated by character code data, and a graphic object indicated by graphic object data are drawn.

Next, referring to FIG. 2 and FIG. 3, a description is given of a relationship between strokes (characters, marks, graphics, tables, etc.), which are handwritten by the user, and time-series information. FIG. 2 shows an example of a handwritten document which is handwritten on the touch-screen display 17 by using the pen 100 or the like.

In many cases, on a handwritten document, other characters or graphics are handwritten over already handwritten characters or graphics. In FIG. 2, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “Λ” shape, a locus of “−” shape) which are handwritten by using the pen 100 or the like, that is, by two loci. The locus of the pen 100 of the first handwritten “Λ” shape is sampled in real time, for example, at regular time intervals, and thereby time-series coordinates SD11, SD12, . . . , SD1n of the stroke of the “Λ” shape are obtained. Similarly, the locus of the pen 100 of the next handwritten “−” shape is sampled, and thereby time-series coordinates SD21, SD22, . . . , SD2n of the stroke of the “−” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 3 illustrates time-series information 200 corresponding to the handwritten document of FIG. 2. The time-series information 200 includes a plurality of stroke data SD1, SD2, . . . , SD7. In the time-series information 200, the stroke data SD1, SD2, . . . , SD7 are arranged in time series in the order of strokes, that is, in the order in which plural strokes were handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the handwritten “Λ” shape of the handwritten character “A”, that is, an n-number of coordinate data SD11, SD12, . . . , SD1n. The stroke data SD2 includes coordinate data series corresponding to the points on the locus of the stroke of the handwritten “−” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “Λ” shape. The coordinate data SD1n is indicative of an X coordinate (X1n) and a Y coordinate (Yin) of the end point of the stroke of the “Λ” shape.

Further, each coordinate data may include time stamp information T corresponding to a time point at which a point corresponding to this coordinate data was handwritten. The time point at which the point was handwritten may be either an absolute time (e.g. year/month/day/hour/minute/second) or a relative time with reference to a certain time point. For example, an absolute time (e.g. year/month/day/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Information (Z) indicative of a pen stroke pressure may be added to each coordinate data.

Furthermore, in the present embodiment, as described above, a handwritten document is stored not as an image or a result of character recognition, but as the time-series information 200 which is composed of a set of time-series stroke data. Thus, handwritten characters and graphics can be handled, without depending on languages. Therefore, the structure of the time-series information 200 of the present embodiment can be commonly used in various countries of the world where different languages are used.

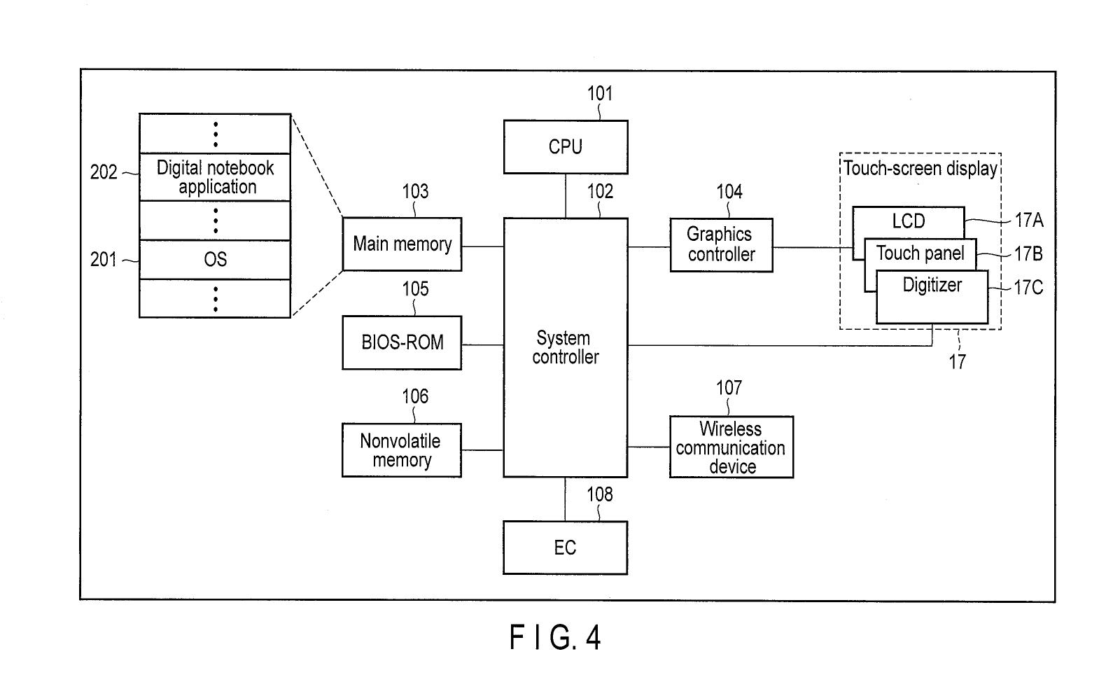

FIG. 4 shows a system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a digital notebook application program 202. The digital notebook application program 202 includes a function of creating and displaying the above-described handwritten document, a function of converting a character handwritten on the handwritten document to a character code and converting a graphic handwritten on the handwritten document to a graphic object, and a function of editing a graphic object by using a handwriting input operation (a handwritten stroke).

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position, are detected by the touch panel 17B. The digitizer 17C is an electromagnetic induction-type pointing device for executing an input on the screen of the LCD 17A. A contact position on the screen, which is touched by the pen 100, and a movement of the contact position, are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of powering on or powering off the tablet computer 10 in accordance with an operation of a power button by the user.

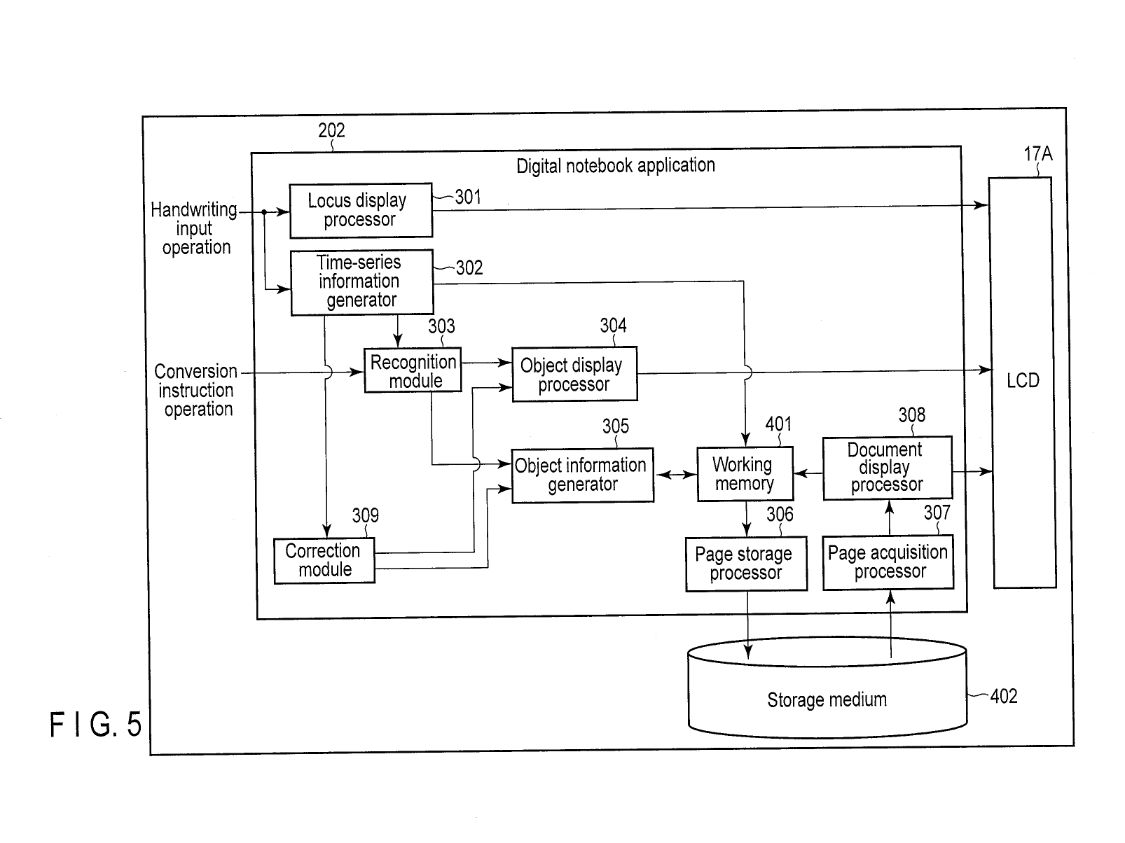

Next, referring to FIG. 5, a description is given of a functional configuration of the digital notebook application program 202. The digital notebook application program 202 executes creation, display and edit of a handwritten document, by using stroke data which is input by a handwriting input operation using the touch-screen display 17. In addition, the digital notebook application program 202 can also convert a character handwritten on a handwritten document to a character code and convert a handwritten graphic to a graphic object.

The digital notebook application 202 includes, for example, a locus display processor 301, a time-series information generator 302, a recognition module 303, an object display processor 304, an object information generator 305, a page storage processor 306, a page acquisition processor 307, a document display processor 308, and a correction module 109.

The touch-screen display 17 is configured to detect the occurrence of events such as “touch”, “move (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The locus display processor 301 and time-series information generator 302 receive an event “touch”, “move (slide)” or “release” which is generated by the touch-screen display 17, thereby detecting a handwriting input operation. The “touch” event includes coordinates of a contact position. The “move (slide)” event includes coordinates of a contact position at a destination of movement. The “release” event includes coordinates of a position (release position) at which the contact position was released from the screen. Thus, the locus display processor 301 and time-series information generator 302 can receive coordinate series, which correspond to the locus of movement of the contact position, from the touch-screen display 17.

The locus display processor 301 receives coordinate series from the touch-screen display 17, and displays, based on the coordinate series, the loci of strokes, which are input by a handwriting input operation using the pen 100 or the like, on the screen of the LCD 17A in the touch-screen display 17. By the locus display processor 301, the locus of the pen 100 during a time in which the pen 100 is in contact with the screen, that is, the locus of each stroke, is drawn on the screen of the LCD 17A.

The time-series information generator 302 receives the above-described coordinate series output from the touch-screen display 17, and generates, based on the coordinate series, the time-series information (stroke data) having the structure as described in detail with reference to FIG. 3. In this case, the time-series information, that is, the coordinates and time stamp information corresponding to the respective points of each stroke, may be temporarily stored in a working memory 401.

The recognition module 303 recognizes a character code and a graphic object, which correspond to handwritten strokes, by using the time-series information generated by the time-series information generator 302. For example, in response to the execution of a conversion instruction operation which instructs conversion of a character and a graphic on the handwritten document to a character code and a graphic object respectively (e.g. an operation of pressing a predetermined button on the screen), the recognition module 303 starts a process of recognizing the character code and graphic object corresponding to the handwritten strokes.

To be more specific, the recognition module 303 recognizes handwritten characters on a handwritten document by using generated time-series information (e.g. time-series information which is temporarily stored in the working memory 401) and character dictionary data. The character dictionary data is prestored in, for example, the storage medium 402, and includes a plurality of entries indicative of features of plural characters (character codes).

The recognition module 303 executes a grouping process on a plurality of stroke data which are indicated by time-series information of a recognition process target, thereby detecting a plurality of blocks (handwriting blocks). In the grouping process, a plurality of stroke data, which are indicated by time-series information of a recognition process target, are grouped such that stroke data corresponding to strokes, which are located close to each other and were successively handwritten, may be classified into the same block.

The recognition module 303 executes a character recognition process for converting a process target block of a plurality of detected blocks to a character code. Using the character dictionary data, the recognition module 303 calculates a similarity between the handwritten character (one or more strokes included in the process target block) and each of a plurality of character codes. The recognition module 303 calculates the similarity between a handwritten character and a character code, for example, based on the shape or stroke order of the character. Then, the recognition module 303 converts the handwritten character to a character code having a highest similarity to this handwritten character.

Based on the character recognition result, the object display processor 304 displays (previews) the character code corresponding to the handwritten character on the handwritten document. Specifically, the object display processor 304 replaces the handwritten character, which is displayed on the handwritten document, with the corresponding character code.

In addition, based on the character recognition result, the object information generator 305 generates character code data indicative of the character code which corresponds to the handwritten character on the handwritten document. The object information generator 305 may temporarily store the generated character code data in the working memory 401.

Furthermore, the recognition module 303 recognizes a handwritten graphic on a handwritten document by using generated time-series information. The recognition module 303 executes a graphic recognition process for converting a process target block of a plurality of blocks, which are obtained by the above-described grouping process of plural stroke data indicated by the time-series information of a recognition process target, to one of a plurality of graphic objects. The handwritten graphic included in the handwritten document is converted to, for example, a graphic object which can be handled by a drawing application program such as PowerPoint (trademark).

The recognition module 303 recognizes a graphic object from one or more handwritten strokes. The recognition module 303 prestores, for example, graphic dictionary data indicative of features of a plurality of graphic objects, and calculates a similarity between the handwritten graphic (one or more strokes included in the process target block) and each of a plurality of graphic objects. Then, the recognition module 303 converts the handwritten graphic to a graphic object having a highest similarity to this handwritten graphic.

This similarity is, for example, a similarity between a feature amount based on time-series information of the handwritten graphic (stroke) and a feature amount based on a contour (shape) of the graphic object. In addition, in the calculation of the similarity, the handwritten graphic may be rotated, enlarged or reduced, where necessary, and a similarity between a handwritten graphic after rotation, enlargement or reduction and each of the plural graphic objects is calculated. Then, the graphic object having a highest similarity to the handwritten graphic is selected, and the selected graphic object is transformed based on a process content of rotation, enlargement or reduction which has been executed on the handwritten graphic. The transformed graphic object is displayed in place of the handwritten graphic.

In the above calculation of the similarity, each of the locus information of the stroke of the handwritten graphic and the locus information of each graphic object may be treated as a set of vectors, and the similarly can be calculated by comparing the sets of vectors. Thereby, the handwritten graphic can easily be converted to a document (application data) of a drawing application such as PowerPoint.

Based on the graphic recognition result, the object display processor 304 displays (previews) the graphic object, which corresponds to the handwritten graphic on the handwritten document, on the screen of the LCD 17. Specifically, the object display processor 304 replaces the handwritten graphic, which is displayed on the handwritten document, with the corresponding graphic object. In the meantime, the object display processor 304 can display on the screen not only the graphic object which was recognized from the handwritten graphic, but also a graphic object which was created by using various tools.

In addition, based on the graphic recognition result, the object information generator 305 generates graphic object data indicative of the graphic object which corresponds to the handwritten graphic on the handwritten document. The object information generator 305 may temporarily store the generated graphic data in the working memory 401. Incidentally, the object information generator 305 can generate graphic object data which is indicative of not only the graphic object which was recognized from the handwritten graphic, but also a graphic object which was created by using various tools.

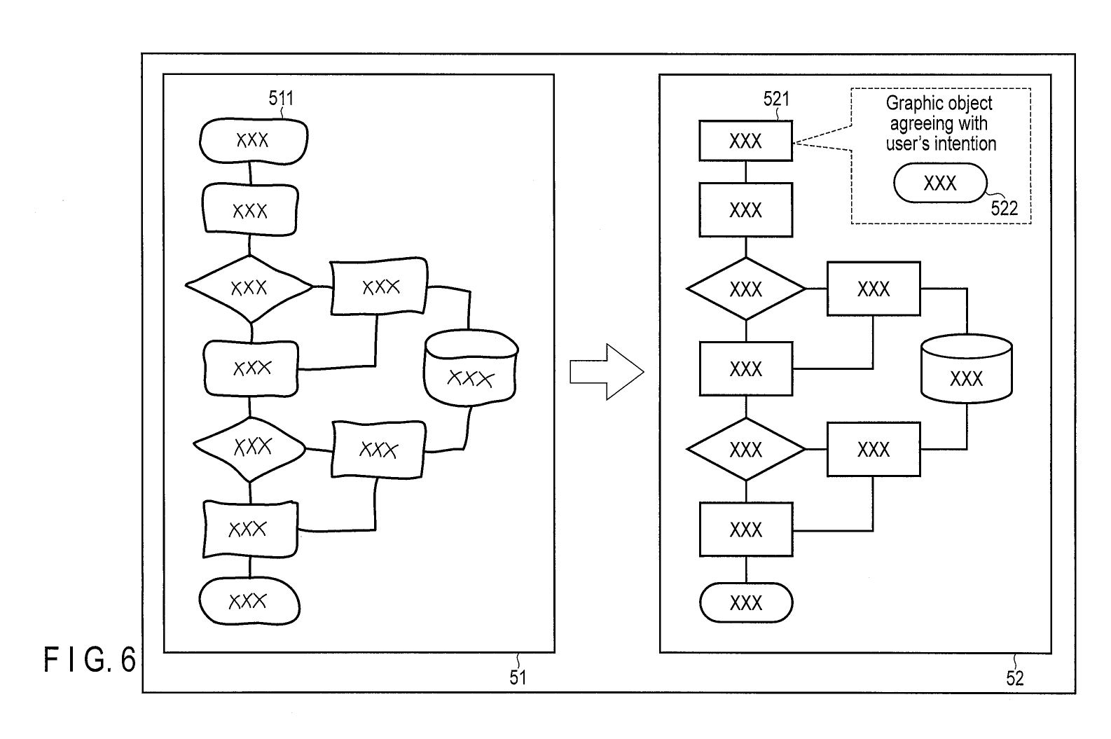

As illustrated in FIG. 6, handwritten characters on a handwritten document 51 are converted to character codes, and handwritten graphics on the handwritten document 51 are converted to graphic objects. Specifically, the recognition module 303 executes a character recognition process on time-series information (time-series stroke data) which corresponds to the handwritten document 51, thereby converting the handwritten characters to character codes, and executes a graphic recognition process on the time-series information, thereby converting the handwritten graphics to graphic objects.

In the meantime, in this graphic recognition process, there is a case in which a handwritten graphic on the handwritten document 51 is recognized as a graphic object which does not agree with the user's intention. In FIG. 6, for example, a handwritten graphic 511 on the handwritten document 51 is erroneously converted to a rectangular graphic object 521, and not to a rounded-cornered rectangular graphic object 522 which agrees with the user's intention. In the recognition process of handwritten graphics, there are cases in which the handwritten graphic is recognized as a graphic object which does not agree with the user's intention, since the shape of the handwritten graphic varies from user to user, or a rough shape, such as a scribbled shape, is handwritten.

In such cases, the user needs to execute an operation of correcting the erroneously converted graphic object to a graphic object which agrees with the user's intention.

As the method of changing the erroneously converted graphic object 521 to a correct graphic object (i.e. the graphic object intended by the user) 522, there is a method of using a changing tool for changing the graphic object. In this method, for example, the user calls a changing tool for changing the graphic object, and executes an operation of selecting the graphic object 522 from a list of a plurality of graphic objects. However, there is a possibility that it is troublesome for the user to perform such an operation during a handwriting input operation. In addition, the changing tool is only able to execute a change to a pre-specified graphic object (i.e. a graphic object indicated in the list), and it is difficult to execute a change to a graphic object which is not specified.

Furthermore, even when a handwritten graphic is recognized as the graphic object which agrees with the user's intention, there is a case in which the user wishes to correct the graphic object to another graphic object. In such a case, too, there is a possibility that it is troublesome for the user to perform an operation using the changing tool.

Thus, in the present embodiment, a character or a graphic is not merely handwritten on a handwritten document by a handwriting input operation, but also a graphic object, which is being displayed, is corrected. For example, a graphic object is corrected based on a handwritten stroke (correction stroke) which is written over the graphic object. Thereby, without using a tool or the like for a graphic object, the graphic object can easily be corrected by a handwriting input operation.

While a first graphic object of a plurality of graphic objects is being displayed on the screen (handwritten document), if a stroke having at least a part thereof in contact with the first graphic object has been handwritten, the correction module 309 of the digital notebook application 202 corrects, based on the stroke and the first graphic object, the first object to a second graphic object which is different from the first graphic object. Specifically, the correction module 309 detects a second graphic object of a plurality of graphic objects by using the stroke having at least a part thereof in contact with the first graphic object.

To be more specific, if time-series information (stroke data) has been generated by the time-series information generator 302 while a graphic object is being displayed on the screen, the correction module 309 detects a stroke (hereinafter also referred to as “correction stroke”), which is intended to correct the graphic object, by using the time-series information. This correction stroke is, for example, a stroke having at least a part thereof in contact with the graphic object, or a stroke crossing a contour of the graphic object. The correction module 309 detects a graphic object, which is in contact with (or crosses) this correction stroke, as a graphic object of a correction target (hereinafter also referred to as “target graphic object”). In the meantime, the correction module 309 may determine whether a handwritten stroke is a stroke which constitutes a character, by using the generated time-series information, and may determine whether this stroke is the above-described correction stroke if this stroke is not a stroke which constitutes a character.

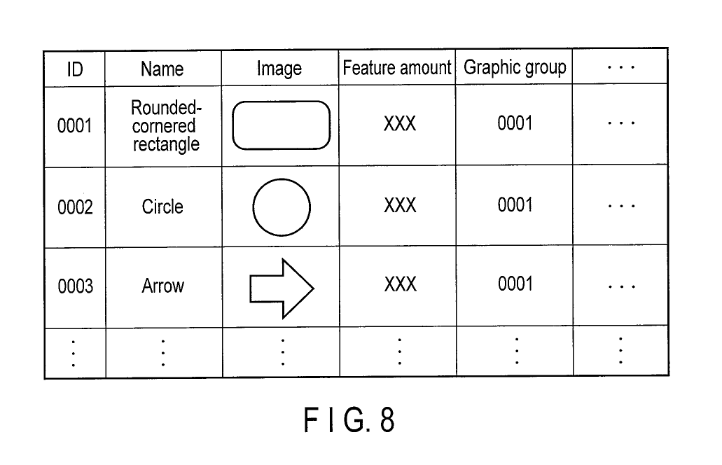

Subsequently, the correction module 309 detects graphic object candidates associated with the target graphic object. By using, for example, graphic dictionary data, the correction module 309 detects graphic objects, which belong to the same graphic group as the target graphic object, as graphic object candidates. For example, similar graphic objects, which tend to be erroneously recognized at a time of the graphic recognition process, belong to this graphic group. Based on the correction stroke, the correction module 309 determines a graphic object (second graphic object) for correcting the target graphic object, from among one or more graphic objects associated with the target graphic object. The correction module 309 determines the second graphic object from among the one or more graphic objects associated with the target graphic object, in accordance with the similarity between the one or more graphic objects and the correction stroke. To be more specific, the correction module 309 calculates the similarity between the correction stroke and each of the graphic object candidates, and replaces the target graphic object with the graphic object having a highest similarity. Like the calculation of the similarity by the recognition module 303, the correction module 309 calculates the similarity by using, for example, the feature amount based on the time-series information corresponding to the correction stroke and the feature amount based on the contour of the graphic object candidate. The graphic dictionary data will be described later with reference to FIG. 8.

The object display processor 304 displays the substituted second graphic object, in place of the target graphic object (first graphic object) displayed on the screen. Specifically, after the correction stroke has been input following the recognition process of the target graphic object, the object display processor 304 displays the second graphic object by replacing the target graphic object with the second graphic object. In addition, the object information generator 305 updates the data of the target graphic object, which is stored in the working memory 401 or the like, to the data of the substituted graphic object.

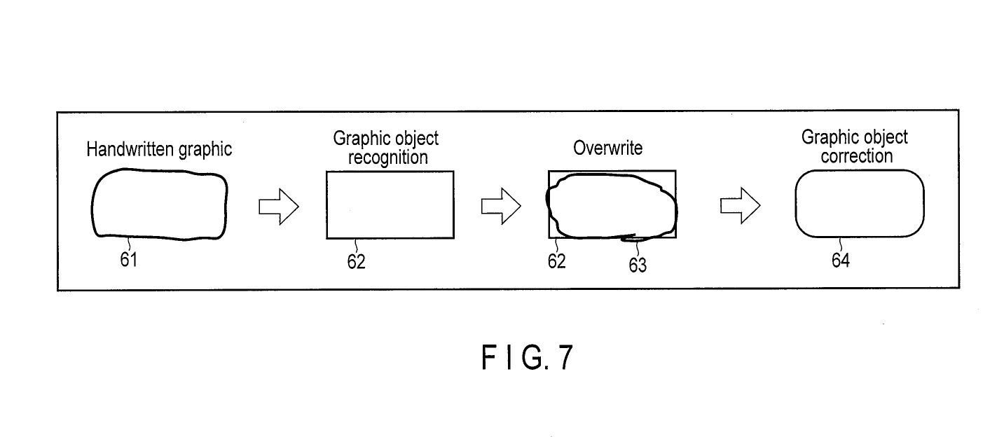

Referring to FIG. 7, a description is given of an example in which an erroneously converted graphic object is corrected. In the example shown in FIG. 7, the case is assumed that a handwritten stroke 61, which was intended for a rounded-cornered rectangle, is recognized as a rectangle which is not intended.

The user first handwrites a stroke 61 of a graphic on a handwritten document, and executes an operation of instructing conversion of the stroke 61 to a graphic object.

The recognition module 303 executes a graphic recognition process on time-series information (stroke data) corresponding to the stroke 61, thereby recognizing, from among a plurality of graphic objects, a rectangular graphic object (first graphic object) 62 corresponding to the stroke (handwritten graphic) 61. For example, by using graphic dictionary data in which feature amounts of plural graphic objects are specified in advance, the recognition module 303 detects the first graphic object 62 having a highest similarity to the stroke 61, from among the plural graphic objects. The object display processor 304 displays the first graphic object 62 by replacing the stroke 61, which is displayed on the screen (handwritten document), with the recognized first graphic object 62.

Since the displayed first graphic object 62 is not the graphic object intended by the user, the user handwrites a correction stroke 63 for correcting the first graphic object 62. This correction stroke is a stroke written over the first graphic object 62 in order to correct the entire contour of the first graphic object 62. The correction stroke 63 has at least a part thereof in contact with the first graphic object 62, and constitutes a closed loop.

In response to the handwriting of the correction stroke 63 on the first graphic object 62, the correction module 309 detects, among the plural graphic objects, a rounded-cornered rectangular graphic object (second graphic object) 64, based on the correction stroke 63 and the first graphic object 62. To be more specific, by using the graphic dictionary data, the correction module 309 detects, among the plural graphic objects, one or more graphic objects associated with the first graphic object 62 (i.e. graphic object candidates belonging to the same graphic group as the first graphic object). Then, the correction module 309 calculates a similarity between each of the one or more graphic objects and the correction stroke 63, and detects the second graphic object 64 having a highest similarity. The object display processor 304 deletes the correction stroke 63 displayed on the screen (handwritten document), and replaces the first graphic object 62 with the detected second graphic object 64, thereby displaying the second graphic object 64 on the screen. Then, the object information generator 305 updates the data of the first graphic object 62, which is stored in the working memory 401 or the like, to the data of the substituted second graphic object 64.

The page storage processor 306 stores at least one of the generated time-series information, character code data and graphic object data (time-series information, character code data and graphic object data, which are temporarily stored in the working memory 401) in the storage medium 402 as handwritten document data. The storage medium 402 is, for example, the storage device in the tablet computer 10.

The page acquisition processor 307 reads arbitrary handwritten document data, which is already stored, from the storage medium 402. The read handwritten document data is sent to the document display processor 308. The document display processor 308 analyzes the handwritten document data, and displays, based on the analysis result, at least one of the locus of each stroke indicated by the time-series information, a character code indicated by the character code data and a graphic object indicated by the graphic object data, on the screen as a handwritten document (handwritten page).

As has been described above, by the operation of writing a correction stroke over a graphic object, the graphic object can be intuitively corrected. Thus, the user can easily change, for example, an erroneously converted graphic object to a correct graphic object.

FIG. 8 illustrates a structure example of the graphic dictionary data. The graphic dictionary data includes a plurality of entries corresponding to a plurality of graphic objects. Each entry includes, for example, an ID, a name, an image, a feature amount, and a graphic group. In an entry corresponding to a certain graphic object, “ID” is indicative of identification information given to this graphic object. “Name” is indicative of the name of the graphic object. “Image” shows the image of the graphic object. The “Image” may be indicative of image data corresponding to the image of the graphic object, or a storage location (file path) of the image data. “Feature amount” is indicative of a feature amount (e.g. feature vector) relating to the shape of the graphic object. “Graphic group” is indicative of a group (or an ID of the group) to which the graphic object belongs. For example, similar graphic objects, which tend to be erroneously recognized at a time of the handwritten graphic recognition process, belong to this group.

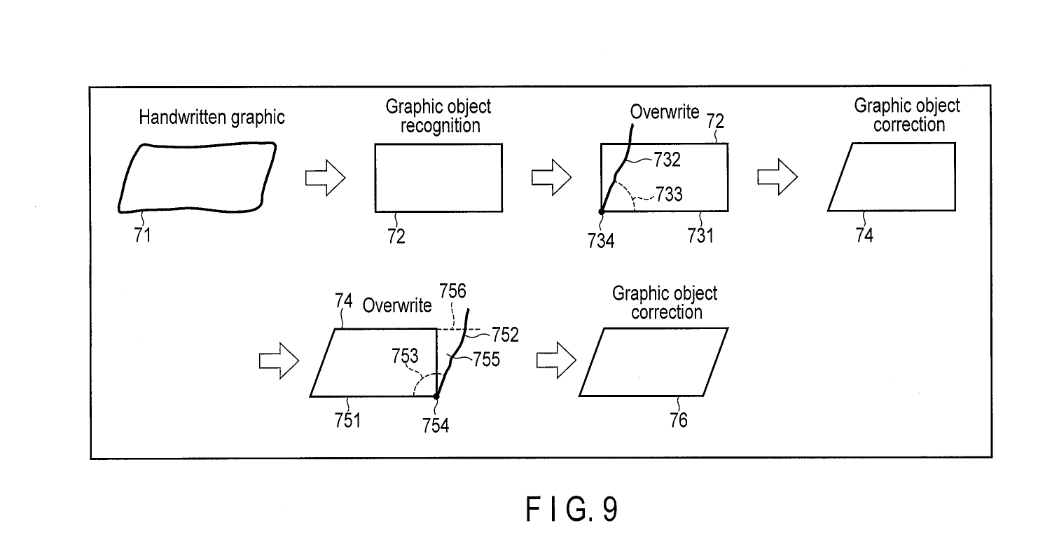

Next, FIG. 9 to FIG. 11 illustrate other examples in which erroneously converted graphic objects are corrected.

In the example illustrated in FIG. 9, the recognition module 303 recognizes a rectangular graphic object 72 corresponding to a handwritten stroke (handwritten graphic) 71. Then, the object display processor 304 replaces the stroke 71, which is displayed on the screen, with the recognized graphic object 72, thereby displaying the graphic object 72.

Since the displayed graphic object 72 is not a parallelogram graphic object which is intended by the user, the user handwrites a correction stroke 732 for correcting the graphic object 72. This correction stroke 732 is, for example, a stroke which has a starting point or an end point in contact with any one of apices of the graphic object 72. Incidentally, the stroke in contact with the apex may be a stroke having a starting point or an end point located within a predetermined range of the apex of the graphic object 72 (e.g. within a range of several pixels from the apex).

The correction module 309 determines a graphic object (second graphic object) for correcting the graphic object 72, from one or more graphic objects which are obtained by cutting out a part of the graphic object 72, based on the correction stroke 732. For example, in response to the handwriting of the correction stroke 732 having a starting point (or an end point) in contact with an apex 734 of the graphic object 72, the correction module 309 cuts out a part of the graphic object 72 (i.e. cuts the graphic object 72), based on this correction stroke 732, thereby acquiring a graphic object 74. For example, the correction module 309 detects an angle 733 which a side 731, which is one of the sides constituting the graphic object 72 and includes the apex 734 in contact with the correction stroke 732, forms with the correction stroke 732. Then, the correction module 309 divides the graphic object 72 by a straight line having this angle 733, and selects one graphic object 74 of the two graphic objects obtained by the division. The selected graphic object 74 is, for example, a graphic object with a larger area of the two graphic objects obtained by the division. Incidentally, the user may be prompted to select one of the two graphic objects obtained by the division. In addition, one of the two graphic objects obtained by the division may be determined based on the direction of the correction stroke 732 (for example, a stroke handwritten in a direction from above to below, or a stroke handwritten in a direction from below to above).

The object display processor 304 deletes the correction stroke 732 displayed on the screen, and replaces the graphic object 72 with the selected second graphic object 74, thereby displaying the graphic object 74. In addition, the object information generator 305 updates the data indicative of the graphic object 72, which is stored in the working memory 401 or the like, to the data indicative of the selected graphic object 74.

Next, in order to correct the graphic object 74 to a parallelogram graphic object, the user further handwrites a correction stroke 752. This correction stroke 752 is, for example, a stroke which has a starting point or an end point in contact with any one of apices of the graphic object 74.

In response to the handwriting of the correction stroke 752 having a starting point (or an end point) in contact with an apex 754 of the graphic object 74, the correction module 309 incorporates into the graphic object 74 an area 755 based on the correction stroke 752 and graphic object 74. For example, the correction module 309 detects an angle 753 which a side 751, which is one of the sides constituting the graphic object 74 and includes the apex 754 in contact with the correction stroke 752, forms with the correction stroke 752. Then, the correction module 309 estimates the area 755 which is to be incorporated in the graphic object 74, based on a straight line having this angle 753 and the graphic object 74. This area 755 can be determined based on a line segment having the angle 753 and a line segment 756 which is an extension of one of the sides constituting the graphic object 74.

The object display processor 304 deletes the correction stroke 752 displayed on the screen, and replaces the graphic object 74 with a graphic object 76 in which the area 755 is incorporated. In addition, the object information generator 305 updates the data indicative of the graphic object 74, which is stored in the working memory 401 or the like, to the data indicative of the substituted graphic object 76.

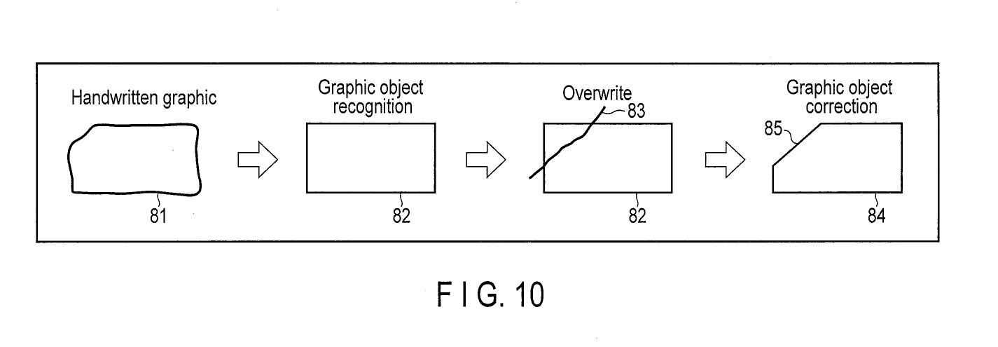

Next, in the example illustrated in FIG. 10, the recognition module 303 recognizes a rectangular graphic object 82 corresponding to a handwritten stroke (handwritten graphic) 81. Then, the object display processor 304 replaces the stroke 81, which is displayed on the screen, with the recognized graphic object 82, thereby displaying the graphic object 82.

Since the displayed graphic object 82 is not a graphic object which is intended by the user, the user handwrites a correction stroke 83 for correcting the graphic object 82. This correction stroke 83 is, for example, a stroke which has at least a part thereof in contact with the graphic object 82.

The correction module 309 determines a graphic object (second graphic object) for correcting the graphic object 82, from one or more graphic objects which are obtained by replacing a part of one or more sides of the sides, which constitute the graphic object 82, with a line segment based on the correction stroke 83. For example, in response to the handwriting of the correction stroke 83, the correction module 309 replaces a part of one or more sides included in the graphic object 82 with a line segment (side) 85 based on the correction stroke 83, thereby acquiring a corrected graphic object 84. The object display processor 304 deletes the correction stroke 83 displayed on the screen, and replaces the graphic object 82 with the corrected graphic object 84, thereby displaying the graphic object 84. In addition, the object information generator 305 updates the data indicative of the graphic object 82, which is stored in the working memory 401 or the like, to the data indicative of the substituted graphic object 84.

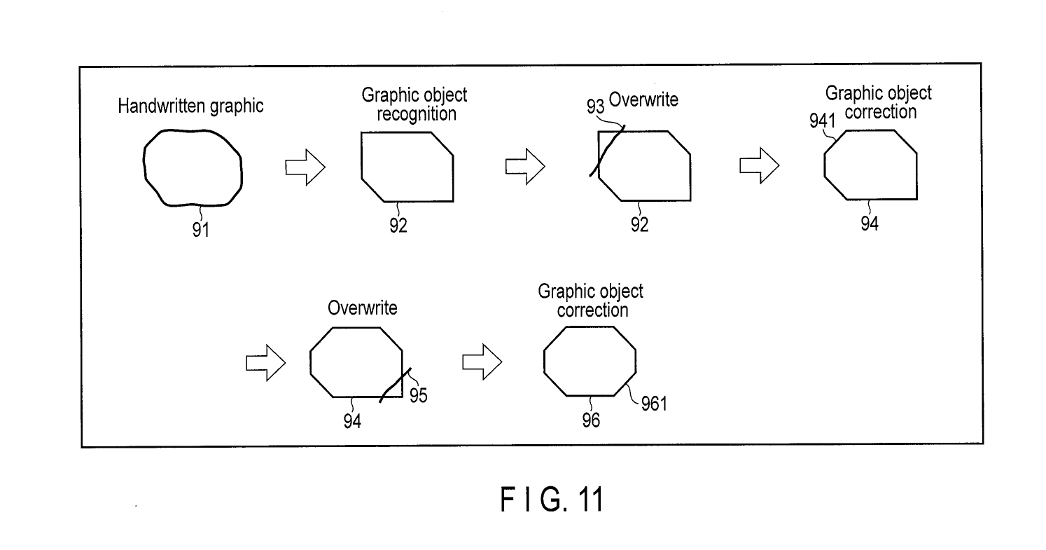

In the example illustrated in FIG. 11, the recognition module 303 recognizes a graphic object 92 corresponding to a handwritten stroke (handwritten graphic) 91. Then, the object display processor 304 replaces the stroke 91, which is displayed on the screen, with the recognized graphic object 92, thereby displaying the graphic object 92.

Since the displayed graphic object 92 is not an octagonal graphic object which is intended by the user, the user handwrites a correction stroke 93 for correcting the graphic object 92. This correction stroke 93 is, for example, a stroke which has at least a part thereof in contact with the graphic object 92.

In response to the handwriting of the correction stroke 93, the correction module 309 replaces a part of one or more sides of the graphic object 92 with a line segment (side) 941 based on the correction stroke 93, thereby acquiring a corrected graphic object 94. The object display processor 304 deletes the correction stroke 93 displayed on the screen, and replaces the graphic object 92 with the corrected graphic object 94, thereby displaying the graphic object 94. In addition, the object information generator 305 updates the data of the graphic object 92, which is stored in the working memory 401 or the like, to the data indicative of the substituted graphic object 94.

Similarly, in response to further handwriting of a correction stroke 95, the correction module 309 replaces a part of one or more sides of the graphic object 94 with a line segment (side) 961 based on the correction stroke 95, thereby acquiring a corrected graphic object 96. The object display processor 304 deletes the correction stroke 95 displayed on the screen, and replaces the graphic object 94 with the further corrected graphic object 96, thereby displaying the graphic object 96. In addition, the object information generator 305 updates the data of the graphic object 94, which is stored in the working memory 401 or the like, to the data indicative of the substituted graphic object 96.

In the examples illustrated in FIG. 9 to FIG. 11, by the operation of handwriting a correction stroke, it is possible to cut out a part of a graphic object, to incorporate an area into a graphic object, or to replace a part of a side included in a graphic object. Thus, a graphic object, which is being displayed, can also be corrected to a graphic object which is not specified in advance in the graphic dictionary data. In other words, by the correction of the graphic object according to the embodiment, it is possible to create a graphic object with a higher degree of freedom than in the case of using, for example, a tool for creating a graphic object which is specified in advance.

In the above-described examples, the description has been given of the case in which the graphic object, which is a target of correction, is a graphic object which was recognized from a handwritten graphic. However, the graphic object of the target of correction is not limited to a graphic object which was recognized from a handwritten graphic, but may be a graphic object which was created by using a tool for creating a graphic object. In short, a graphic object, which was created (edited) by using a tool or the like, can similarly be corrected by using the above-described correction stroke.

In addition, the handwritten graphic recognition process (the process by the recognition module 303) may be executed not in the tablet computer 10 but by a server computer, etc. connected over a network. In this case, the tablet computer 10 (digital notebook application 202) transmits time-series information (stroke data) indicative of handwritten strokes to the server, and receives data indicative of a character code and graphic object recognized by the server. In the tablet computer 10, the character code and graphic object are displayed on the screen, based on the received data. Then, the above-described correction process can be executed on the displayed graphic object.

In the meantime, the above-described correction examples of graphic objects are merely examples, and the process based on the above-described correction stroke is applicable to, for instance, all kinds of graphic objects which are used in drawing graphics applications.

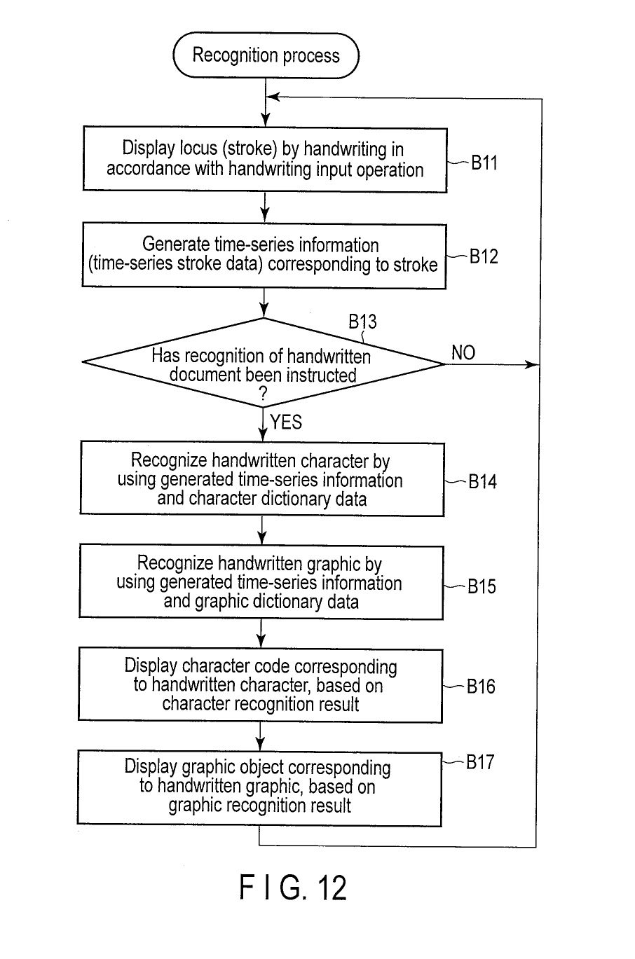

Next, referring to a flowchart of FIG. 12, a description is given of an example of the procedure of a recognition process executed by the digital notebook application 202.

To start with, the locus display processor 301 displays on the display 17A the loci (strokes) of movement of the pen 100 or the like by a handwriting input operation (block B11). In addition, the time-series information generator 302 generates the above-described time-series information (plural stroke data arranged in the time-series order), based on the coordinate series corresponding to the loci by the handwriting input operation, and temporarily stores the time-series information in the working memory 401 (block B12).

Subsequently, the recognition module 303 determines whether recognition of a handwritten document has been instructed or not (block B13). The recognition module 303 determines that recognition of a handwritten document has been instructed, for example, in response to execution of a conversion instruction operation (e.g. an operation of pressing a predetermined button on the screen) which instructs conversion of a character and a graphic on the handwritten document to a character code and a graphic object, respectively. When recognition of a handwritten document has not been instructed (NO in block B13), the process returns to block B11, and a process corresponding to a handwriting input operation is continued.

On the other hand, when recognition of a handwritten document has been instructed (YES in block B13), the recognition module 303 recognizes a handwritten character on the handwritten document, by using the generated time-series information (e.g. time-series information temporarily stored in the working memory 401) and character dictionary data (block B14). In addition, by using the generated time-series information and graphic dictionary data, the recognition module 303 recognizes a handwritten graphic on the handwritten document (block B15).

Subsequently, based on the character recognition result, the object display processor 304 displays a character code corresponding to the handwritten character on the handwritten document (block B16). In addition, based on the graphic recognition result, the object display processor 304 displays a graphic object corresponding to the handwritten graphic on the handwritten document (block B17). Then, the process returns to block B11, and a process corresponding to a further handwriting input operation is continued.

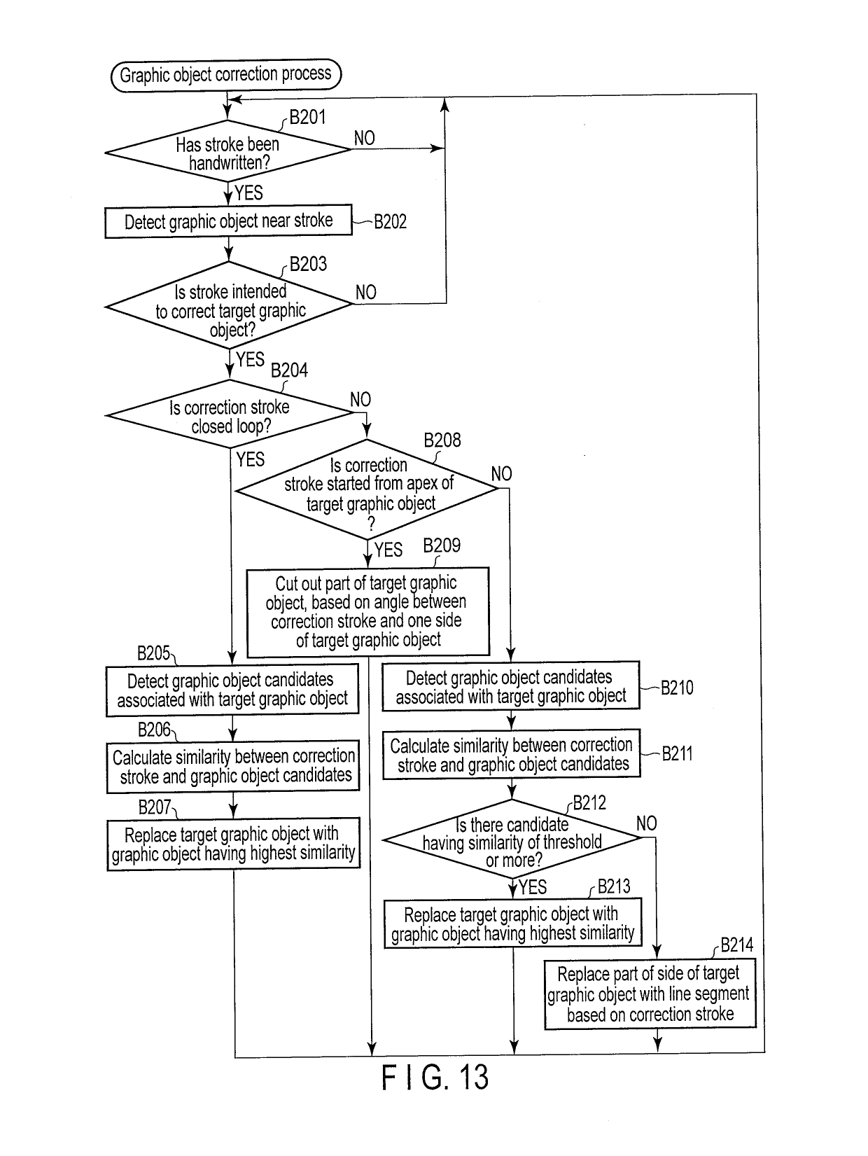

Referring to a flowchart of FIG. 13, a description is given of an example of the procedure of a graphic object correction process executed by the digital notebook application 202. In the description below, the case is assumed that a graphic object corresponding to a handwritten graphic on a handwritten document is displayed on the screen by the above-described recognition process, that is, a handwritten graphic on a handwritten document has been replaced with a corresponding graphic object.

To start with, the correction module 309 determines whether a stroke has been handwritten or not (block B201). For example, when time-series information (stroke data) has been generated by the time-series information generator 302, the correction module 309 determines that a stroke has been handwritten on the screen. When no stroke has been handwritten on the screen (NO in block B201), the process returns to block B201, and it is determined once again whether a stroke has been handwritten or not.

When a stroke has been handwritten (YES in block B201), the correction module 309 detects a graphic object near the stroke (block B202). Then, the correction module 309 determines whether the handwritten stroke is intended to correct the detected graphic object (target graphic object) (block B203). For example, when the stroke and the target graphic object are in contact (i.e. when a part of the stroke and a part of the target graphic object overlap), the correction module 309 determines that the handwritten stroke is intended to correct the target graphic object.

When the stroke is not intended to correct the graphic object (NO in block B203), the process returns block B201.

When the stroke is intended to correct the graphic object (YES in block B203), it is determined whether the stroke (correction stroke) constitutes a closed loop or not (block B204). When the correction stroke constitutes a closed loop (YES in block B204), the correction module 309 detects graphic object candidates associated with the target graphic object (block B205). For example, by using graphic dictionary data, the correction module 309 detects, as graphic object candidates, graphic objects belonging to the same graphic group as the target graphic object. The correction module 309 calculates a similarity between the correction stroke and each of the graphic object candidates (block B206). Then, the correction module 309 replaces the target graphic object with a graphic object having a highest similarity (block B207). An example of this replacement is as has been described above with reference to FIG. 7. The object display processor 304 displays the substituted graphic object in place of the target graphic object which is displayed on the screen. In addition, the object information generator 305 updates the data of the target graphic object, which is stored in the working memory 401 or the like, to the data of the substituted graphic object.

When the correction stroke does not constitute a closed loop (NO in block B204), the correction module 309 determines whether the correction stroke is started from an apex of the target graphic object (block B208). For example, when the starting point or end point of the correction stroke is within a predetermined range of the apex of the target graphic object (e.g. within a range of several pixels from the apex), the correction module 309 determines that the correction stroke is started from the apex of the target graphic object.

When the correction stroke is started from the apex of the target graphic object (YES in block B208), the correction module 309 cuts out a part of the target graphic object, based on an angle which the correction stroke forms with one side of the target graphic object (block B209). An example of this cutting-out is as has been described above with reference to FIG. 9. The object display processor 304 displays the cut-out graphic object in place of the target graphic object which is displayed on the screen. In addition, the object information generator 305 updates the data of the target graphic object, which is stored in the working memory 401 or the like, to the data of the cut-out graphic object.

When the correction stroke is not started from the apex of the target graphic object (NO in block B208), the correction module 309 detects graphic object candidates associated with the target graphic object (block B210). The correction module 309 calculates a similarity between the correction stroke and each of the graphic object candidates (block B211). Then, the correction module 309 determines whether there is a graphic object candidate having a similarity of a threshold or more (block B212).

When there is a graphic object candidate having a similarity of the threshold or more (YES in block B212), the correction module 309 replaces the target graphic object with a graphic object having a highest similarity (block B213). The object display processor 304 displays the substituted graphic object in place of the target graphic object which is displayed on the screen. In addition, the object information generator 305 updates the data of the target graphic object, which is stored in the working memory 401 or the like, to the data of the substituted graphic object.

When there is no graphic object candidate having a similarity of the threshold or more (NO in block B212), the correction module 309 replaces a part of one or more sides of the target graphic object with a line segment based on the correction stroke (block B214). An example of this replacement is as has been described above with reference to FIG. 10 and FIG. 11. The object display processor 304 displays the graphic object with a part of the side thereof being replaced, instead of the target graphic object which is displayed on the screen. In addition, the object information generator 305 updates the data of the target graphic object, which is stored in the working memory 401 or the like, to the data of the graphic object with a part of the side thereof being replaced.

As has been described above, according to the present embodiment, a graphic object can be easily changed by a handwriting input operation. The object display processor 304 displays a first graphic object of a plurality of graphic objects on the screen. When a stroke having at least a part thereof in contact with the first graphic object has been handwritten, the correction module 309 detects a second graphic object of a plurality of graphic objects, based on this stroke and the first graphic object. Then, the object display processor 304 displays the second graphic object by replacing the first graphic object on the screen with the detected second graphic object. Thereby, in the embodiment, the first graphic object can easily be changed to the second graphic object by using the stroke handwritten on the first graphic object.

All the process procedures in the present embodiment, which have been described with reference to the flowcharts of FIG. 12 and FIG. 13, can be executed by software. Thus, the same advantageous effects as with the present embodiment can easily be obtained simply by installing a program, which executes the process procedures, into an ordinary computer through a computer-readable storage medium which stores the program, and by executing the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display controller configured to display a first graphic object of a plurality of graphic objects on a screen; and
a processor configured to change, if a stroke is handwritten and at least a part of the stroke overlaps with the first graphic object, the first graphic object to a second graphic object which is different from the first graphic object, based on the stroke and the first graphic object,
wherein the display controller is configured to display the second graphic object in place of the first graphic object.

2. The electronic apparatus of claim 1, wherein the processor is configured to determine the second graphic object from among one or more graphic objects based on the stroke, the one or more graphic objects being associated with the first graphic object.

3. The electronic apparatus of claim 2, wherein the processor is configured to determine the second graphic object from among the one or more graphic objects, in accordance with a similarity between the one or more graphic objects and the stroke.

4. The electronic apparatus of claim 1, wherein the processor is configured to determine the second graphic object from among one or more graphic objects which are obtained by cutting out a part of the first graphic object based on the stroke.

5. The electronic apparatus of claim 1, wherein the processor is configured to determine the second graphic object from among one or more graphic objects which are obtained by replacing a part of one or more sides, which constitute the first graphic object, with a line segment based on the stroke.

6. The electronic apparatus of claim 1, wherein the first graphic object is a graphic object recognized based on one or more strokes which are handwritten, and
the display controller is configured to display the second graphic object in place of the first graphic object after the stroke is input following a recognition process of the first graphic object.

7. The electronic apparatus of claim 1, further comprising a recognition module configured to recognize the first graphic object from one or more strokes which are handwritten.

8. The electronic apparatus of claim 1, further comprising a touch-screen display,
wherein the display controller is configured to display the first graphic object or the second graphic object on the touch-screen display, and
the stroke is input through the touch-screen display.

9. A handwritten document processing method comprising:
displaying a first graphic object of a plurality of graphic objects on a screen; and
changing, if a stroke is handwritten and at least a part of the stroke overlaps with the first graphic object, the first graphic object to a second graphic object which is different from the first graphic object, based on the stroke and the first graphic object,
wherein the displaying comprises displaying the second graphic object in place of the first graphic object.

10. The handwritten document processing method of claim 9, wherein the changing comprises determining the second graphic object from among one or more graphic objects based on the stroke, the one or more graphic objects being associated with the first graphic object.

11. The handwritten document processing method of claim 10, wherein the changing comprises determining the second graphic object from among the one or more graphic objects, in accordance with a similarity between the one or more graphic objects and the stroke.

12. The handwritten document processing method of claim 9, wherein the changing comprises determining the second graphic object from among one or more graphic objects which are obtained by cutting out a part of the first graphic object based on the stroke.

13. The handwritten document processing method of claim 9, wherein the changing comprises determining the second graphic object from among one or more graphic objects which are obtained by replacing a part of one or more sides, which constitute the first graphic object, with a line segment based on the stroke.

14. The handwritten document processing method of claim 9, wherein the first graphic object is a graphic object recognized based on one or more strokes which are handwritten, and
the displaying comprises displaying the second graphic object in place of the first graphic object after the stroke is input following a recognition process of the first graphic object.

15. The handwritten document processing method of claim 9, further comprising recognizing the first graphic object from one or more strokes which are handwritten.

16. The handwritten document processing method of claim 9, wherein the displaying comprises displaying the first graphic object or the second graphic object on a touch-screen display, and
the stroke is input through the touch-screen display.

17. A computer-readable, non-transitory storage medium having stored thereon a program which is executable by a computer, the program controlling the computer to execute functions of:
displaying a first graphic object of a plurality of graphic objects on a screen; and
changing, if a stroke is handwritten and at least a part of the stroke overlaps with the first graphic object, the first graphic object to a second graphic object which is different from the first graphic object, based on the stroke and the first graphic object,
wherein the displaying comprises displaying the second graphic object in place of the first graphic object.

18. The computer-readable, non-transitory storage medium of claim 17, wherein the changing comprises determining the second graphic object from among one or more graphic objects based on the stroke, the one or more graphic objects being associated with the first graphic object.

19. The computer-readable, non-transitory storage medium of claim 18, wherein the changing comprises determining the second graphic object from among the one or more graphic objects, in accordance with a similarity between the one or more graphic objects and the stroke.

20. The computer-readable, non-transitory storage medium of claim 17, wherein the changing comprises determining the second graphic object from among one or more graphic objects which are obtained by cutting out a part of the first graphic object based on the stroke.

21. The computer-readable, non-transitory storage medium of claim 17, wherein the changing comprises determining the second graphic object from among one or more graphic objects which are obtained by replacing a part of one or more sides, which constitute the first graphic object, with a line segment based on the stroke.

22. The computer-readable, non-transitory storage medium of claim 17, wherein the first graphic object is a graphic object recognized based on one or more strokes which are handwritten, and
the displaying comprises displaying the second graphic object in place of the first graphic object after the stroke is input following a recognition process of the first graphic object.

23. The computer-readable, non-transitory storage medium of claim 17, further comprising recognizing the first graphic object from one or more strokes which are handwritten.

24. The computer-readable, non-transitory storage medium of claim 17, wherein the displaying comprises displaying the first graphic object or the second graphic object on a touch-screen display, and
the stroke is input through the touch-screen display.
